(19) United States
(12) Patent Application Publication
(10) Pub. No.: US 2019/0243387 A1
(43) Pub. Date: Aug. 8, 2019

(54) Method And System For Autonomous And Random Drone Travel

(71) Applicants: Imani R. OAKLEY, Mt. Clair, NJ (US); Warren DENNIS, Newport News, VA (US); Alphonzo ST. FLEUR, Loganville, GA (US); Derrick S. ANANG, Washington,, DC (US)

(72) Inventors: Imani R. Oakley, Mt. Clair, NJ (US); Warren Dennis, Newport News, VA (US); Alphonzo St. Fleur, Loganville, GA (US); Derrick S. Anang, Washington, DC (US)

(21) Appl. No.: 16/091,754

(22) PCT Filed: Apr. 6, 2017
(86) PCT No.: PCT/US17/26402

§ 371 Date: Oct. 5, 2018

Related U.S. Application Data
(60) Provisional application No. 62/319,110, filed on Apr. 6, 2016.

(51) Int. Cl. G05D 1/10; B64C 39/02; B64C 3/00; G01C 21/20

(52) U.S. Cl. CPC G05D 1/101; B64C 39/024; B64C 3/00; A63H 27/00; B64C 2201/141; B64C 2201/12; B64D 2203/00; G01C 21/20

(57) ABSTRACT

An aerial device is provided. The aerial device includes a processor and a memory that includes instructions configured to cause the processor to perform certain operations when the processor executes the instructions. The operations may include receiving a first signal indicative of a first position of the aerial device. The operations may also include generating, based on the first signal and based on a randomly generated sequence, a second signal configured to actuate flight hardware of the aerial device to a second position.

### CROSS-REFERENCE TO RELATED APPLICATIONS

The present disclosure claims the benefit of U.S. Provisional Patent Application No. 62/31,110, filed on Apr. 6, 2016, the disclosure of which is incorporated herein in its entirety by reference.

### TECHNICAL FIELD

The present disclosure relates to drones. More particularly, the present disclosure relates to methods and systems for providing autonomous travel and random travel paths for drones.

### BACKGROUND

Drone technology is becoming increasingly prevalent in a wide variety of applications. For example, it has been suggested that, in the very near future, flying drones will serve as carriers for parcel delivery. Moreover, drones are now routinely used in military applications, and their use in urban areas for policing is also expected to become standard. Marine research may also benefit from submersible drones equipped with a plethora of sensors capable of probing specific underwater biological processes and provide telemetry in real time. Further, recreational drones are by far the most widely used, as they are inexpensive relative to their aforementioned counterparts.

Nevertheless, despite their widespread use and potential benefits, typical drones are “passive” machines that require at least some degree of user input for travel. For example, most recreational drones are typically remote-controlled. In the case of autonomous drones, i.e., drones that may travel without user intervention, a predetermined travel path is typically programmed into the drone, or the drone may be equipped to sense specific cues from its environment to help guide it towards a predetermined destination.

### BRIEF SUMMARY

The embodiments described herein provide an autonomous drone that can fly randomly within a given region, without user input. Such a drone can thus be employed in a wide variety of recreational or surveillance applications. In the case of recreational activities, the novel drone may be used in Quidditch games, as depicted in the Harry Potter movies and described in J. K. Rowling's famed book series. In other words, the novel drone may be used as “Golden Snitch.” In the case of surveillance applications, the novel drone may be used as a patrol drone that is configured to move about a predefined region without user intervention, and randomly.

One exemplary embodiment of the novel drone is an aerial device that includes a processor and a memory including instructions configured to cause the processor to perform certain operations when the processor executes the instructions. The operations may include receiving a first signal indicative of a first position of the aerial device. The operations may also include generating, based on the first signal and based on a randomly generated sequence, a second signal configured to actuate flight hardware of the aerial device to a second position.

In another exemplary embodiment, the operations may include determining a current position of the aerial device while the aerial device is in flight and planning a random flight path for the aerial device where the random flight path originates from the current position. Further, in yet another exemplary embodiment, the operations may include receiving a first signal indicative of a position of the aerial device and autonomously plan a random flight path to a second another position. The operations may further include generating a second signal configured to cause the aerial device to move along the random flight path to the second position.

Additional features, modes of operations, advantages, and other aspects of various embodiments are described below with reference to the accompanying drawings. It is noted that the present disclosure is not limited to the specific embodiments described herein. These embodiments are presented for illustrative purposes. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates a drone in accordance with one embodiment.

FIG. 2 illustrates another view of the drone of FIG. 1 in accordance with one embodiment.

FIG. 3 illustrates a wing in accordance with one embodiment.

FIG. 4 illustrates another drone in accordance with one embodiment.

FIG. 5 depicts a block diagram of a drone controller in accordance with one embodiment.

FIG. 6 illustrates another block diagram for a drone controller in accordance with one embodiment.

FIG. 7 illustrates a flow chart of a method in accordance with one embodiment.

FIG. 8 illustrates a circuit implementation of a kill switch feature in accordance with one embodiment.

FIG. 9 illustrates a component in accordance with one embodiment.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility. For example, while the exemplary embodiments are described in the context of a flying drone, one of skill in the art will readily recognize that the teachings featured herein also extend generally to land-based and marine-based drones.

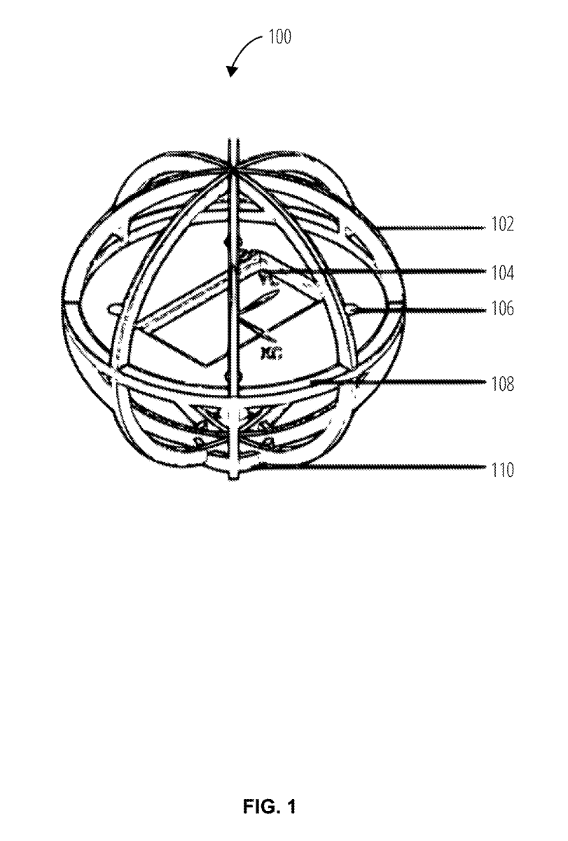

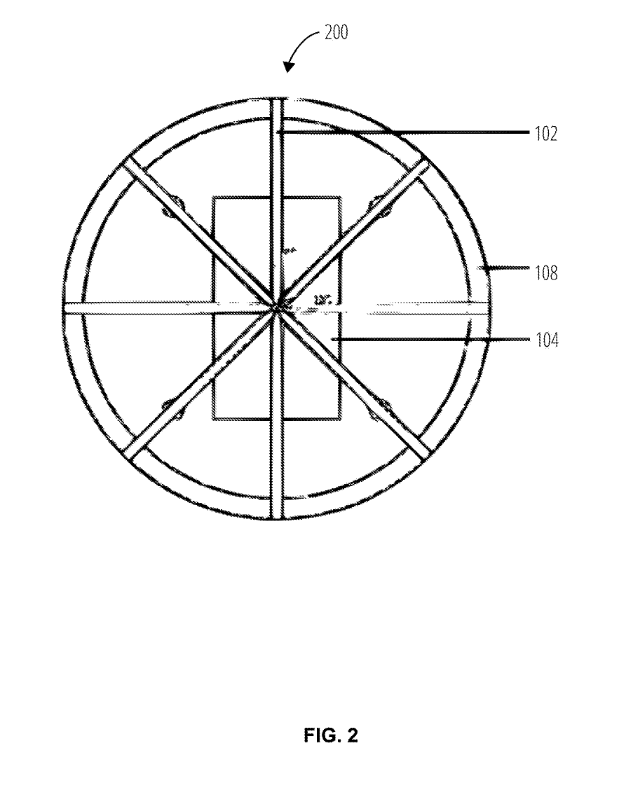

FIG. 1 illustrates a drone 100 according to an embodiment, and FIG. 2 illustrates a top view 200 of the drone 100. As shall be described below in greater detail, the drone 100 is an aerial vehicle configured to perform autonomous flight and generate random flight paths. The drone 100 includes a shell 102, forming a housing or a cage that serves to enclose several key components of the drone 100.

The housing can be made of plastic, or of other materials or combinations of materials. For example, the shell 102 can be made of a metal mesh. Furthermore, the shell 102 forms a spherical pattern as shown in FIG. 2, and has several openings. The propellers (not shown) can access the ambient air around the drone 100, causing the drone 100 to fly.

The drone 100 further includes a compartment 104 to house a control system for the drone 100. For example, the compartment 104 can include electrical systems, batteries, and microcontroller chips. These components cooperatively function to cause the drone 100 to fly autonomously along randomly generated flight paths determined in real-time.

The drone 100 further includes a plurality of recesses 106 each serving to fit a motor and a propeller. The motor is controllable via one or more wires extending from the control system housed in the compartment 104. As shown in FIG. 1, the drone 100 features four recess 106, each capable of housing a single propeller Therefore, as configured, the drone 100 is a quad-copter. Generally, other drones configurations, such as single-propeller drones, can also be used without departing from the scope of the present disclosure.

The drone 100 also includes a barrier 108 that fuses both halves of the sphere formed by the shell 102. For increased functionality, the compartment 104 can also have control system components placed in the bottom half of the sphere formed by the shell 102. Such additional components can include sensors, such as inertial sensors, GPS modules, additional batteries, antennas, and the like. The drone 100 further includes a substantially flat pole region which forms a support system 110 that provides a resting surface for the drone 100 when it has landed.

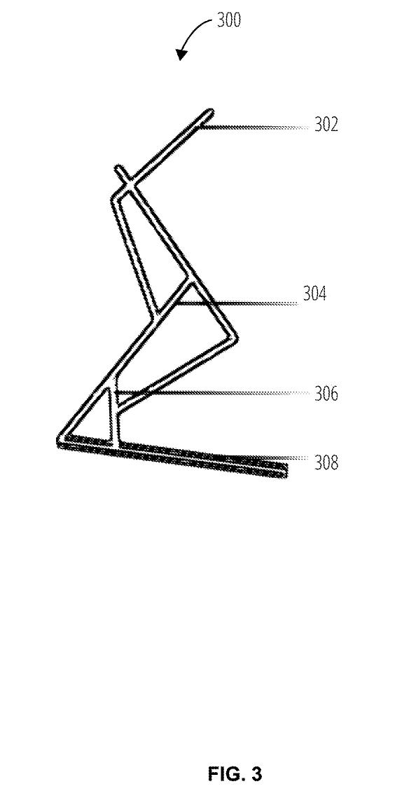

In some embodiments, the drone 100 can include additional structural features. For example, the drone 100 can include light emitting diodes (LEDs) mounted around the outer surface of the shell 102. In yet other embodiments, one or more wings like wing 300, shown in FIG. 3, can be mounted on an outer surface of the shell 102 (e.g., at an outer surface of the barrier 108). The set of wings may not necessarily participate in flight, but can be ornamental features of the drone 100.

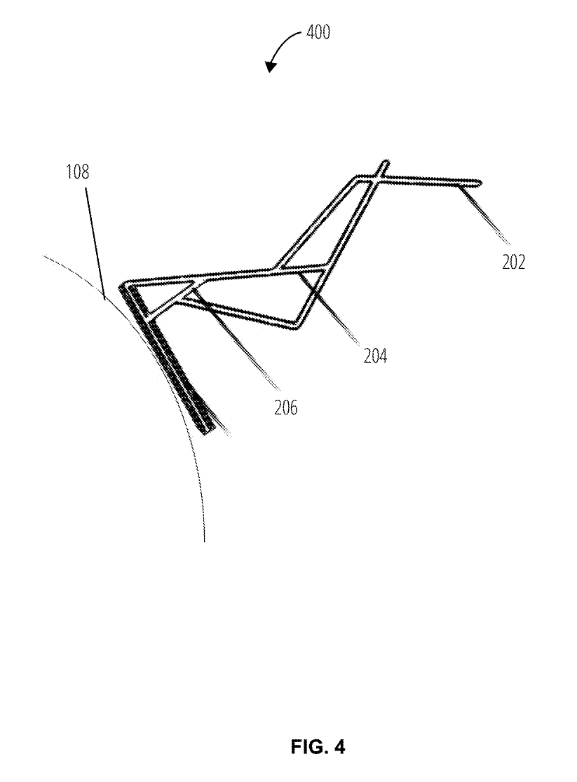

As depicted in FIG. 3, the wing 300 can be made of a material lighter than the shell 102. As such, the wing 300 may not actively interfere with the flight of the drone 100. In yet other embodiments, each wing 300 mounted on the drone 100 may be retractable. As shown in FIG. 3, the wing 300 includes a tip 302, a stationary axel 304, and a non-stationary axel 306 that can slide along a support rod 308, the latter being affixed onto the body of the drone 100, at the barrier 108, as depicted in the view 400 of FIG. 4.

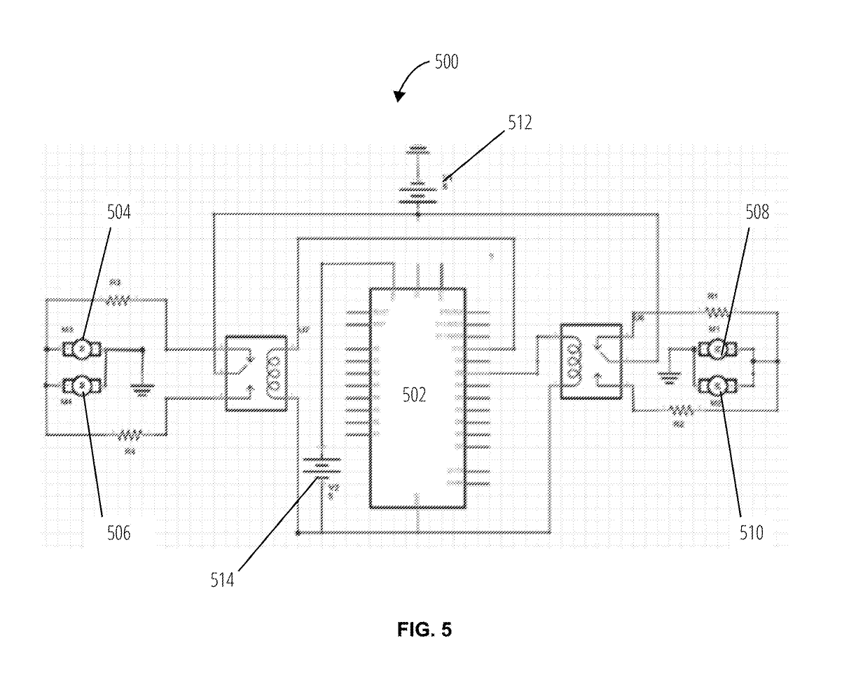

FIG. 5 illustrates a block diagram of a control system 500 that can be used to control the drone 100 autonomously and that can generate random flight paths. The control system includes a controller 502 housed in the compartment 104. The controller 502 can be an application-specific system, i.e., an embedded computer having a specific structure and software architecture that impart the drone 100 the functionalities described herein.

The specific structure is imparted to the controller 502 by instructions that are located in a memory of the controller 502. The controller 502 is electrically coupled to a set of motors, each being equipped with a propeller. In the case of the drone 100, the controller 502 controls four motors (504, 506, 508, and 510). Switching relays to the motors may be powered by a battery 512, and the controller 502 may be powered by a battery 514.

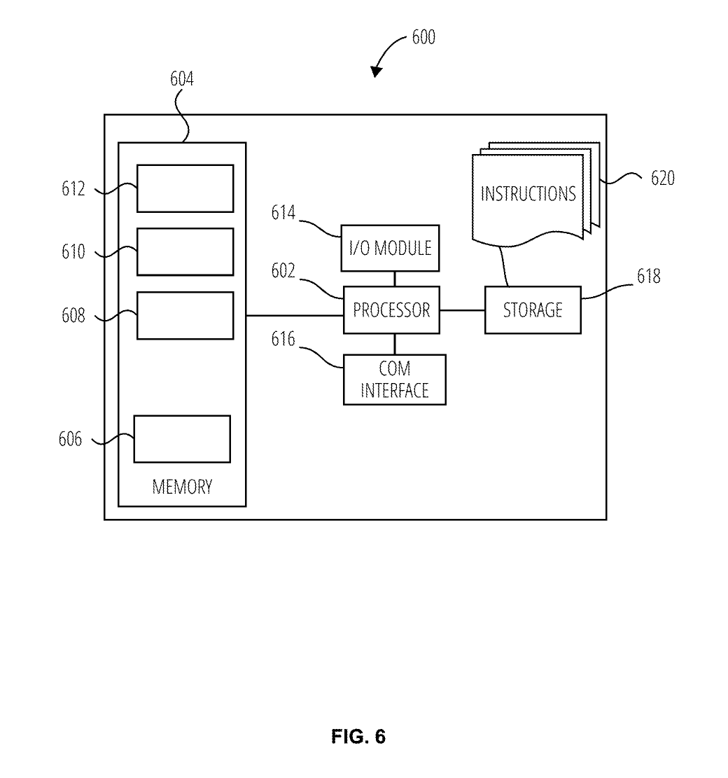

FIG. 6 illustrates a block diagram 600 of the controller 502, i.e., of its specific architecture imparted by a specific set of instructions. The instructions cause the controller 502 to actuate the flight hardware of the drone 100 (i.e., motors and propellers) to provide autonomous travel and random flight paths.

The controller 502 includes a processor 602 that has a specific structure. The specific structure is imparted to processor 602 by instructions stored in a memory 604 included therein and/or by instructions 620 that can be fetched by the processor 602 from a storage medium 618. The storage medium 618 may be co-located with the controller 502 or can be located elsewhere and be communicatively coupled to controller 502. The controller 502 can be a stand-alone programmable system, or can be a programmable module located in a much larger system. For example, the controller 502 can be part of a system-on-a-chip (SoC) architecture that also includes a transceiver module that allows uplinks and downlinks from and to remote devices.

The controller 502 may include one or more hardware and/or software components configured to fetch, decode, execute, store, analyze, distribute, evaluate, and/or categorize information. Furthermore, the controller 600 can include an input/output (I/O) 614 that configured to interface with a remote device, for example. The remote device may send a signal to the controller 502 to cause it to land when it is in flight, effectively allowing for a kill switch. In other words, the controller 502 may be configured to receive a signal that causes the drone 100 to lower its altitude and land, and turn off its propellers. Upon landing, the drone 100 may then turn on an LED, an RF burst signal, or a combination thereof in order to allow a user to locate the drone 100.

The processor 602 may include one or more processing devices or cores (not shown). In some embodiments, the processor 602 may be a plurality of processors, each having either one or more cores. The processor 602 can be configured to execute instructions fetched from memory 604, i.e. from one of the memory block 612, the memory block 610, the memory block 608, or the memory block 606, or the instructions may be fetched from the storage medium 618 or from a remote device connected to the controller 502 via a communication interface 616.

Furthermore, without loss of generality, storage medium 618 and/or memory 604 may include a volatile or non-volatile, magnetic, semiconductor, tape, optical, removable, non-removable, read-only, random-access, or any type of non-transitory computer-readable computer medium. Storage medium 618 and/or memory 604 may include programs and/or other information that may be used by processor 602. Furthermore, storage medium 618 may be configured to log data processed, recorded, or collected during the operation of controller 600. The data may be time-stamped, location-stamped, cataloged, indexed, or organized in a variety of ways consistent with data storage practice.

In one embodiment, for example, the memory block 606 may include instructions that, when executed by the processor 602, cause processor 602 to perform certain operations. The operations can include receiving a first signal indicative of a first position of the drone 100 and generating, based on the first signal and based on a randomly generated sequence, a second signal configured to actuate motion hardware (i.e., one or more of the motors 504, 506, 508, and 510) of the drone 100 to cause the drone 100 to move to a second position. The processor 602 may then continue in a loop and receive another first signal that is indicative of a current position of the drone 100 and subsequently generate another random sequence to cause the drone 100 to move to yet another position.

The random sequence may be, for example, a randomly generated finite set of 3-dimensional coordinates, i.e., x, y, and z triplets. Taken together, the randomly generated set of coordinates form a randomly generated flight path. One of skill in the art will readily recognize that one or more random numbers (i.e., the coordinates) may be generated using instructions that cause the processor 602 to sample a random variable and yield the random number. Generally, known methods for producing random numbers in computer systems can be programmed into the controller 502 to provide the above-mentioned features.

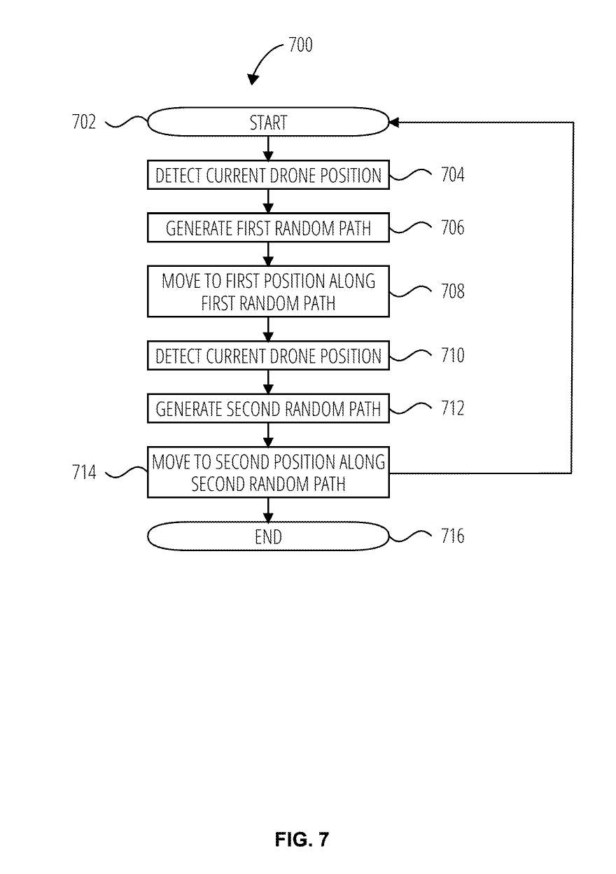

A method 700 that is consistent with the embodiments' operation is described in reference to FIG. 7. The method 700 can begin at step 702, and it may include detecting at step 704, by a position sensor located on-board the drone 100, a current position of the drone 100. The position sensor may then transmit a signal indicative of the position of the drone 100 to the processor 602, which, based on the current position, generates (step 706) a random path of travel for the drone 102.

The random path of travel originates from the current position and ends at another position that is effectively random relative to the current position of the drone 100. The drone 100 is then caused by the processor 602, by actuating its motion hardware, to move to the other position along the random path of travel (step 708). The above-mentioned steps (704, 706, and 708) can be repeated in steps 710, 712, and 714 to move the drone 100 to yet another random position. The method 700 can then end at step 716 or it may continue in a loop and start again at step 702.

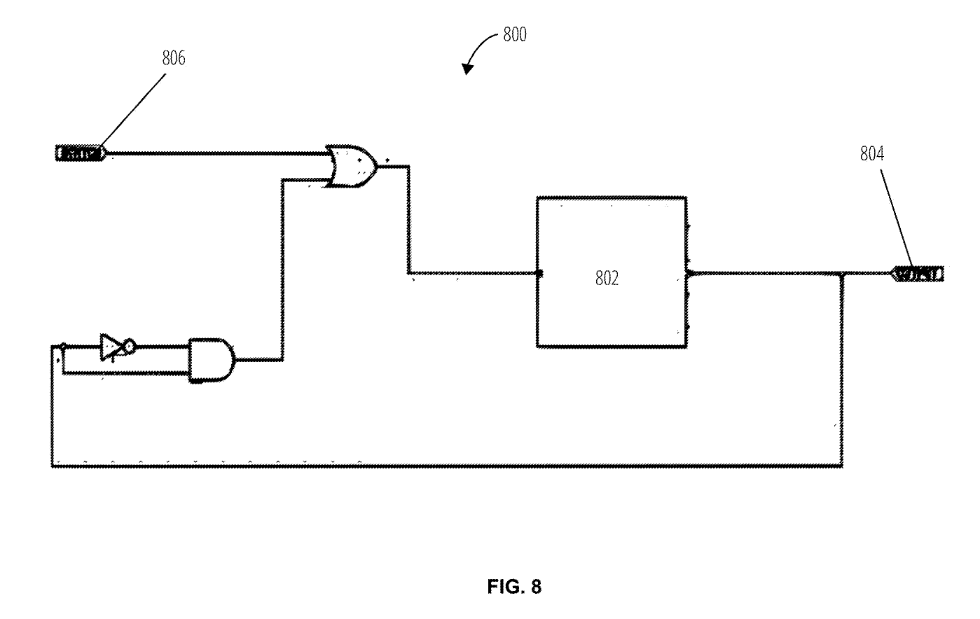

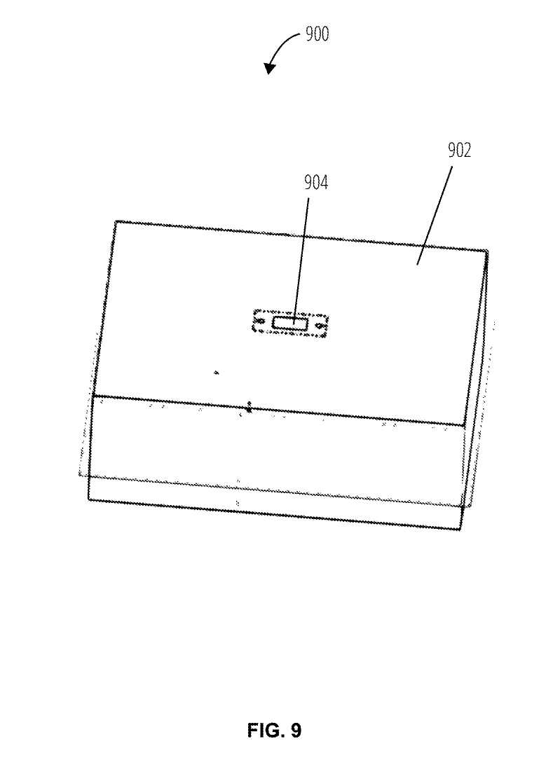

FIG. 8 illustrates an exemplary circuit 800 for implementing the above-mentioned kill switch feature. The circuit 800, once on by the actuation of a switch at the input 806 switch on, can cut off the propellers that are responsible left and right movement of the drone 100, varying the current output of the motor circuit 802. Once on, the circuit 800 can further reduce the velocity of the propellers responsible for lift so the drone 100 can lower itself to the ground. Lastly, the circuit 800 can switch on an LED light that will flash a light signal at the output 804 so that a user can locate the drone 100. FIG. 9 shows a remote device 900 that can be used to implement the kill switch features. The remote device 900 can include a housing 902 through which there is an opening to provide access to a button 904. Once the button is pressed, the kill switch feature is engaged and an interrupt signal can be transmitted to the drone 100 to instruct it to land as described above with respect to the circuit 800.

Generally, embodiments may include a drone (e.g., an aerial device) that includes a processor and a memory. The memory may include instructions that, when executed by the processor, cause the processor to perform operations. The operations may include receiving a first signal indicative of a first position of the drone and generating, based on the first signal and based on a randomly generated sequence, a second signal configured to actuate motion hardware of the drone to a second position. When the drone is an aerial device, the second signal is thus configured to actuate flight hardware (e.g., motors and propellers) to move the aerial device to the second position. When the drone is a land-based device, the second signal can engage wheels, chains, motors, to cause the drone to move to the second position.

The operations may further include generating, based on a third signal indicative of the second position and on another randomly generated sequence, a fourth signal configured to actuate the drone's motion hardware to move the drone from the second position to a third position. In other words, the drone can move to another position randomly. When the-aforementioned set of operations is performed by the processor continuously, the result is effectively a drone that moves randomly and continually, though the random motion can be constrained within a predetermined perimeter or within a predetermined volume.

The drone may include a position sensor, such as one that would be provided by an on-board global positioning module or by on-board inertial sensors, such as an accelerometer. The processor may be configured to receive the first signal from such a position sensor. Furthermore, the processor may be configured to receive an interrupt signal that causes the drone to enter into a shutdown sequence. A shutdown sequence can be construed herein as a set of operations effectuated by the processor to cause the drone to cease its functioning and be retrieved by a user.

For example, for an aerial device, the shutdown sequence can include causing the device to decrease its altitude (i.e., to lower its z-component) until it lands and to turn off its propellers. Subsequently, the shutdown sequence can further include turning on a beacon to allow a user to retrieve the drone. Such a beacon can be either a strobing set of light of emitting diodes, or a repeating RF burst, or a combination thereof. The interrupt signal may be received wirelessly by the drone. Such a capability can be provided by an on-board transceiver module that is communicatively coupled to the processor.

In some embodiments, the random path may be constrained within a predetermined geographical region. Specifically, though the drone can move randomly, the drone's motion can be made to stay within a certain perimeter and/or below a certain altitude. Such constraints can be placed on the drone's motion by instructing the processor to discard any coordinate(s) included in generated random path that put(s) the drone outside of the constrained region. This ensures that the drone remains within the desired region, while being able to move randomly within that region.

The drone may further include an obstacle detection sensor. The obstacle detection sensor can be either an on-board radar system or a LIDAR system or the like. Upon detecting an obstacle, the drone may initiate the generation of a random path from its current position in order to avoid the obstacle. As such, when the drone moves about the randomly generated path in response to detecting an obstacle, the drone takes an evasive action and maneuvers away from the obstacle.

In some embodiments, the drone may include a shell or a housing that is configured to house the processor, the memory, and motion hardware, such as propellers and motors in the case of an aerial drone. Furthermore, in the case of an aerial drone, in some embodiments, the device may include retractable wings. Although the wings can be retracted towards the drone's body or extended away from the drone's body, the wings do not actively participate in causing the drone's flight. As such, the wings may be ornamental in nature. This feature may be appealing to a user when the drone is a toy.

In general, the operations of the processor may include receiving a first signal indicative of a position of the drone and planning a random path along which the drone will subsequently travel autonomously to a second position. For example, when the drone is an aerial device, the processor may generate a second signal configured to cause the aerial device to move along a random flight path to the second position. The random flight path can be thought of as a set of randomly generated x, y, and z triplets of coordinates.

Those skilled in the relevant art(s) will appreciate that various adaptations and modifications of the embodiments described above can be configured without departing from the scope and spirit of the disclosure. Therefore, it is to be understood that, within the scope of the appended claims, the teachings set forth in the present disclosure may be practiced other than as specifically described herein.

What is claimed is:

1. An aerial device, comprising:
a processor;
a memory including instructions that, when executed by the processor, cause the processor to perform operations comprising:
receiving a first signal indicative of a first position of the aerial device; and
generating, based on the first signal and based on a randomly generated sequence, a second signal configured to actuate flight hardware of the aerial device to a second position.

2. The aerial device of claim 1, wherein the operations further include generating, based on a third signal indicative of the second position and on another randomly generated sequence, a fourth signal configured to actuate the flight hardware to move the aerial device from the second position to a third position.

3. The aerial device of claim 1, further comprising a position sensor.

4. The aerial device of claim 3, wherein the operations further include receiving the first signal from the position sensor.

5. The aerial device of claim 1, wherein the operations further include receiving an interrupt signal configured to cause the aerial device to set down when the aerial device is in flight.

6. The aerial device of claim 5, wherein receiving the interrupt signal includes receiving the interrupt signal wirelessly.

7. An aerial device, comprising:
a processor;
a memory including instructions that, when executed by the processor cause the processor to perform operations including:
determining a current position of the aerial while the aerial device is in flight; and
planning a random flight path for the aerial device, the random flight path originating from the current position.

8. The aerial device of claim 7, wherein the random flight path is constrained within a predetermined geographical region.

9. The aerial device of claim 7, wherein the random flight path is constrained within an area and below a predetermined altitude.

10. The aerial device of claim 7, further comprising an obstacle detection sensor.

11. The aerial device of claim 10, wherein the operations further include receiving a signal from the obstacle detection sensor and planning the random flight path in response to receiving the signal.

12. The aerial device of claim 10, wherein the aerial device further includes a set of wings that do not actively contribute to flight.

13. The aerial device of claim 10, wherein the aerial device further includes a shell configured to house the processor, the memory and flight hardware.

14. The aerial device of claim 13, wherein the flight hardware includes a set of propellers and a set of motors.

15. The aerial device of claim 7, further including a transceiver module connectable to a remote device.

16. The aerial device of claim 15, wherein the operations further include receiving an interrupt signal via the transceiver module, the interrupt signal being configured to cause the aerial device to land when the aerial device is in flight.

17. An aerial device, comprising:
a processor;
a memory including instructions that, when executed by the processor, cause the processor to perform operations comprising:
receiving a first signal indicative of a position of the aerial device;
autonomously plan a random flight path to a second another position; and
generating a second signal configured to cause the aerial device to move along the random flight path to the second position.

18. The aerial device of claim 17, wherein the random flight path is based on a set of randomly generated coordinates.

19. The aerial device of claim 18, wherein each coordinate of the set of coordinate includes at least two of an x, y, and z component set.

20. The aerial device of claim 17, wherein the operations further include receiving an interrupt signal configured to cause the aerial device to land.
